(19) United States
(12) Patent Application Publication
(10) Pub. No.: US 2025/0380128 A1
(43) Pub. Date: Dec. 11, 2025

(54) PROVISION AND COLLECTION METHODS, BASE STATION, DATA COLLECTION AND ANALYSIS DEVICE, AND SYSTEM

(71) Applicant: Orange, Issy-les-Moulineaux (FR)

(72) Inventors: Charles Hartmann, Chatillon (FR); Antoine Mouquet, Chatillon (FR)

(21) Appl. No.: 18/876,920

(22) PCT Filed: Jun. 22, 2023
(86) PCT No.: PCT/EP2023/067013

§ 371 Date: Dec. 19, 2024

(30) Foreign Application Priority Data
Jun. 27, 2022 (FR) FR2206373

(51) Int. Cl. H04W 8/24; H04W 16/18

(52) U.S. Cl. CPC H04W 8/24; H04W 16/18

(57) ABSTRACT

A method for providing information by a base station of a cellular communications network is provided. The method includes, following a request to a network data collection and analysis device, transmitting, to the collection and analysis device, information representative of current deployment conditions of at least one network cell managed by the base station.

### PRIOR ART

The invention belongs to the general field of telecommunications.

It more specifically relates to the delivery of information for improving certain functionalities implemented by entities of a cellular communication network. The invention has a preferable but non-limiting application within the context of a cellular communication system or network based on a 5G core network (or 5GC) as defined by the 3GPP standard. Within this context, it notably improves the functionalities implemented by a data collection and analysis device of the network, which is also referred to as an NWDAF (“NetWork Data Analytics Function”) device.

Modern communication networks, such as 5G networks defined by the 3GPP standard, encounter complex situations, which are notably the result of the very large number of user equipments (or UEs) to be managed, of the variety of ways the network is used (and requirements in terms of latency, throughput, resulting volumetry), as well as of the various behaviors of the network users over time and space. In order to deal with these complex situations, the operators install one or more specialized entities within their networks that are responsible for collecting data from the network and for using this data to carry out statistical analyses and predictions (also referred to as “analytics”), for example relating to the request and the response provided by the network in terms of quality of service. These predictions can be global predictions, i.e., they can be established on the network, a server, an application or even a region. Examples of global predictions are a network resource load rate, the average quality of service, the number of users connected to the network via their user equipments or active sessions. Individual predictions, i.e., concerning a user or a group of users, can also be established, such as, for example, the future location of the UE of the user or the volumetry of a future communication session of the user established via their UE. By way of illustration, the NWDAF function performs such a role in a 5G core network.

Making predictions using an NWDAF function assumes the prior collection of raw data representing network facts (for example, connected state of the UE, cell in which it is located, etc.) from various entities forming the network, also commonly referred to as “network functions” (or NFs). This raw data can be global data concerning each NF function, or can even relate to each user. Once established, the predictions allow corrective modifications to be implemented on the parameters of the network in an anticipated manner in order to optimize its operation. The entities using these predictions are typically NF functions, clients of the NWDAF function, which may or may not be distinct from the NF functions that collected and delivered the raw data to the NWDAF function, such as, for example, an AMF (“Access and Mobility management Function”) function, an SMF (“Session Management Function”) function, etc. These client NF functions are then able to adapt their behavior according to the predictions received from the NWDAF function in order to optimize the operation of the network and the quality of the service delivered to each user on their UE.

3GPP document TR 23.791, entitled “Technical Specification Group Services and System Aspects; Study of Enablers for Network Automation for 5G (Release 16)”, V16.2.0, June 2019, mentions various cases for using such predictions in a 5G network. Thus, for example, the mobility predictions of the UEs can be used by the AMF function to optimize the management of the mobility of the UEs, and in particular to optimize the determination of their registration area (or RA), this registration area allowing UEs in idle mode to be located and allowing paging messages to be sent to them when data intended for them reaches the network, etc. According to another example, it can be worthwhile to use the SMF function to provide statistics or predictions concerning the network traffic when selecting a UPF (“User Plane Function”) function for routing the data of the PDU (“Packet Data Unit”) sessions.

It is therefore clearly understood, in view of their importance in the operational functioning of the network, that the statistics and/or the predictions delivered by the NWDAF function must be precise and relevant.

### Disclosure of the invention

The invention improves the precision and the relevance of the statistics and/or predictions delivered by a data collection and analysis device of a network, such as an NWDAF network function in a 5G network. To this end, it proposes a method for delivering information using a base station of a cellular communications network, with this method comprising, after being polled by a data collection and analysis device of the network, a step of sending said collection and analysis device information representing current deployment conditions of at least one cell of the network managed by the base station.

Correspondingly, the aim of the invention is a base station of a cellular communications network comprising a transmission module activated after being polled by a data collection and analysis device of the network, with said module being configured to send said collection and analysis device information representing current deployment conditions of at least one cell of the network managed by the base station.

The invention therefore proposes providing the data collection and analysis devices of the network with information representing the current deployment conditions of the cells of the network (such as, for example, adjacency relations of the cells), so that said one or more devices can use the information when establishing predictions and/or statistics requested of them. This information can be used to provide more precise and more relevant predictions and/or statistics taking into account the deployment context of the cells of the network.

Furthermore, providing the collection and analysis devices of the network with such information allows the artificial intelligence (or AI) models used by these one or more devices, if applicable, to be provided with enriched input data, and thus allows more precise and more relevant AI models to be constructed for the purposes/objectives of the network functions polling the one or more collection devices. Typically, by enriching the input data of the AI models with the information representing the current deployment conditions of the cells of the network, it is possible to reveal new associations and/or to eliminate variables that are not very relevant in terms of the goals of the processing operations implemented by the client network functions.

By virtue of the invention, the quality of the decisions made in the core network thus can be improved.

Information representing current deployment conditions of a cell is understood to mean information reflecting the actual conditions in which the cell is deployed at the considered instant. Various types of information are involved. For example, at least one of said items of information representing current deployment conditions relates to:
an arrangement of the cell in a network architecture (for example, coverage, radio proximity);
a geographical environment of the cell;
a type of deployment of the cell;
a configuration of at least one antenna of the cell;
at least one infrastructure covered by the cell (for example, road, railway track, building, etc.); and/or
a state of the cell (for example, load of the cell, load on each network slice, number of active users, uplink (UL) throughput or downlink (DL) throughput, congestion indicators, alarm state, security state, etc.).

This information is dynamic and is likely to evolve over time, typically due to a reconfiguration of the base stations, the appearance of new infrastructures, the suppression of certain cells (for example, small cells provided for capacitive reasons, during periods when the network is hardly used, like at night, in order to reduce the energy consumption of the network), etc. Awareness of the actual deployment of the network cells can be used to improve the efficiency of the procedures implemented in the network, and incidentally the resulting quality of service. For example, the mobility predictions of a UE carried out by an NWDAF network function in a 5G network can be facilitated and their precision can be improved if it is understood that the UE is moving on a main road. According to another example, the congestion information of a cell or the average throughput achieved for UL and/or for DL can influence the quality of service predictions, and incidentally the decisions taken based on these predictions.

It should be noted that other information relating to said at least one cell managed by the base station, in addition to the information relating to the current deployment conditions of the cell, can be sent to the collection and analysis device, such as, for example, static configuration information of the cell, such as:
an identity of said at least one cell; and/or
a frequency band allocated to said at least one cell; and/or
at least one radio access technology associated with said at least one cell;
etc.;
   or other information more related to the operational functioning of the network, such as, for example, a cell belonging to a TA (“Tracking Area”), with a TA being able to include one or more cells of the cellular network.

Of course, this list is not exhaustive, and it is possible to contemplate enriching the knowledge of the collection and analysis device with yet more information, such as, for example, with information relating to the base station that is already known and shared by the base station in the prior art, such as its identity, the list of TAs and/or network slices that it supports, or information relating to a state of the base station (for example, load level, congestion level), etc.

In a particular embodiment, the information is sent by the base station to the collection and analysis device by exposing it via an application programming interface of the base station.

Correspondingly, the base station can be configured to implement an application programming interface to expose said information representing current deployment conditions of at least one cell of the network managed by the base station, with said application programming interface being used by said transmission module.

Exposing information via an Application Programming Interface (API) of the base station, such as, for example, a RESTful API, facilitates the implementation of the invention and allows the control plane of the network to be used. It allows some principles and protocols to be re-used that are already implemented by the core network, particularly within the context of a 5GC core network. An additional management layer does not need to be used, which would render the system more complex and would limit the dynamics of the exchanges of information, for example if the deployment conditions are modified (for example, linked to an automatic reconfiguration of a base station and to the modification of the neighboring information that may be derived therefrom).

In a manner known per se, an API is a standardized set of classes, methods/functions, types of data and/or constants, that acts as an interface with an entity (in this case with the base station) to provide other entities with services (namely, in this case, providing information relating to the current deployment conditions of the cells managed by the base station). Exposing this information with the base station via an API therefore also facilitates access to this information by network devices other than a data collection and analysis device, such as, for example, by any other device of the core network hosting a network function as long as it is able to invoke this API.

As mentioned above, the invention preferably applies within the context of a 5G network. However, it can be used in other contexts. Indeed, some participants in the telecommunications field anticipate, for the 6^{th} generation of mobile networks (also more commonly called 6G), the suppression of the borders between the one or more access networks and the core network. With this in mind, the network architectures based on control plane signaling interfaces can have significant advantages, granting access to the internal contexts specific to the virtualized equipments/functions of the network. The invention therefore can be easily applied in such a context as well.

There is no limit associated with how the base station is polled by the collection and analysis device in order to send the information representing the current deployment conditions of all or some of the cells that it manages.

Thus, in a particular embodiment, polling the base station involves receiving a request from the collection and analysis device concerning said information, with said information being sent in a response to said request.

In other words, the polling initiating the transmission of the information representing the current deployment conditions of the cells managed by the base station can respond to a one-off or recurrent request from the collection and analysis device. By sending such a request, the collection and analysis device can advantageously target a particular base station and/or specific information that it wishes to acquire.

In another embodiment, said polling involves the collection and analysis device subscribing to the base station for notifications of events likely to affect said current deployment conditions of said at least one cell, with said information being sent in a notification of at least one of said events.

This embodiment advantageously allows the collection and analysis device to be automatically notified, without delay, of any changes affecting the current deployment conditions of the cells managed by the base station.

It should be noted that such information representing the current deployment conditions of the cells is, with the exception of some information relating to the state of the cell, not currently known to the base stations: the base station is unaware of the actual deployment context of the cells that it manages, and it only has radio parameters that it uses to manage the quality of the radio links, to maintain the communications using measurements that it carries out and/or that are fed back by the UEs and/or to broadcast cell selection/reselection parameters to the UEs. This type of information is not actually currently used by the base stations in the processing operations assigned to them. As for the information relating to the state of the cell and/or of the base station, it is not shared with the core network.

In a particular embodiment, all or some of the information relating to the current deployment conditions of the network cells can be configured on the base stations by the network operator (for example, in the form of unstructured metadata (for example, XML, JSON, YAML formats, etc.) in a data repository that is standardized or is specific to the network operator) or can be acquired or determined by the base stations themselves.

Thus, the delivery method can comprise a step of evaluating at least a portion of said information before sending it to the collection and analysis device.

By way of illustration, it is possible to contemplate the base station evaluating the geographical range of the coverage area of a cell based on the geographical positions of the UEs served by the cell, with these positions being able to be provided by satellite positioning modules (for example, GPS (“Global Positioning System”), GNSS (“Global Navigation Satellite Systems”)) installed on the UEs or be deduced by the base station based on information it has available concerning these UEs, such as their speed or an Observed Time Difference of Arrival (OTDOA).

As a variant, the delivery method further comprises a step of acquiring, from a network-adapted radio planning system, at least a portion of said information before sending it to said collection and analysis device.

A radio planning system can typically provide information concerning the type of deployment contemplated for the cell: in a dense, suburban or rural area, in the direct line-of-sight (or LOS) or nonline-of-sight (or NLOS), event-driven or temporary deployment, configuration of the cell (for example, macro-, micro-or pico-cell), configuration of the antennas of the cell (for example, Distributed Antenna System (or DAS)), etc. It can also provide information concerning the infrastructures covered by the cell, for example if it is deployed to cover a main road, a waterway, a port, a railway track, a station, and, if applicable, to identify the infrastructures in question.

As can be seen in light of the above, the invention uses the base stations of the cellular network configured to send the one or more collection and analysis devices of the network information representing the current deployment conditions of the cells that it manages, but also information concerning the one or more collection and analysis devices configured to receive such information and, if applicable, to use said information.

Thus, according to another aspect, a further aim of the invention is a method for collecting data using a data collection and analysis device of a cellular communication network, said method comprising:
a step of receiving information from at least one base station of the network polled by said collection and analysis device, with said information representing current deployment conditions of at least one cell of the network managed by said at least one base station; and
a step of using all or some of said received information when analyzing network data.

Correspondingly, the invention also relates to a data collection and analysis device of a cellular communications network comprising:
a polling module, configured to poll at least one base station of the network;
a receiving module, configured to receive information from said at least one polled base station representing current deployment conditions of at least one cell of the network managed by said at least one base station; and
an analysis module, configured to use all or some of said received information when analyzing network data.

The collection method and device benefit from the same aforementioned advantages as the delivery method and the base station.

As mentioned above, in a particular embodiment, at least one of said base stations is polled by the collection and analysis device by sending a request concerning said information, with said information being received in a response from the base station to said request.

In another embodiment, at least one of said base stations is polled by the collection and analysis device by subscribing to the base station for notifications of events likely to affect said current deployment conditions of at least one of said cells managed by the base station, with said information being received in a notification from the base station of at least one of said events.

These two embodiments can be used exclusively or in combination.

In a particular embodiment, the collection method comprises a step of sending a result of said analysis to another network device that requested this analysis.

Such a result is, for example, a prediction (for example, a prediction of the mobility of a user equipment managed by said other device) and/or statistics using the information concerning cell deployment conditions provided by the base stations of the network.

In a particular embodiment, the collection method further comprises a preliminary step of selecting at least one of said polled base stations, with said selection being carried out as a function of at least one given selection criterion and/or of at least one of said items of information representing current deployment conditions of at least one of said cells.

As mentioned above, the invention provides a high degree of flexibility. The collection and analysis device can choose which of the one or more base stations it wishes to poll, and, if applicable, which information it wishes to acquire on which of the one or more cells, depending, for example, on the statistics and/or predictions the other network devices have requested from said collection and analysis device. This limits the amount of information exchanged over the network between the base stations and the collection and analysis device and that is stored by the collection and analysis device.

In a particular embodiment, the delivery and collection methods are implemented by a computer.

A further aim of the invention is a computer program on a storage medium, with this program being able to be implemented in a computer or more generally in a base station according to the invention and comprising instructions adapted for implementing a delivery method as described above.

A further aim of the invention is a computer program on a storage medium, with this program being able to be implemented in a computer or more generally in a collection and analysis device according to the invention and comprising instructions adapted for implementing a collection method as described above.

Each of these programs can use any programming language, and can be in the form of source code, object code, or of intermediate code between source code and object code, such as in a partially compiled format, or in any other desirable format.

A further aim of the invention is an information medium or a computer-readable storage medium, comprising instructions of a computer program as mentioned above.

The information or storage medium can be any entity or device capable of storing the programs. For example, the medium can comprise a storage means, such as a ROM, for example a CD-ROM or a microelectronic circuit ROM, or even a magnetic storage means, for example, a hard disk, or a flash memory.

Moreover, the information or storage medium can be a transmissible medium such as an electrical or optical signal, which can be routed via an electrical or optical cable, via a radio link, via a wireless optical link or via other means.

The program according to the invention can particularly be downloaded over a network of the Internet type.

Alternatively, the information or storage medium can be an integrated circuit, in which a program is incorporated, with the circuit being adapted to execute or to be used to execute the delivery and collection methods according to the invention.

According to another aspect, the invention also relates to a system in a cellular communication network comprising:
at least one base station according to the invention; and
at least one collection and analysis device according to the invention.

In a particular embodiment, the base station implements an application programming interface in order to expose the information relating to the current deployment conditions of said at least one cell that it manages, and the system comprises at least one other device of the network hosting a network function and configured to invoke the application programming interface implemented by the base station.

This embodiment notably allows network functions of the core network other than the collection and analysis device to access the information relating to the current deployment conditions of the cells managed by the base station.

It is also possible to contemplate, in other embodiments, that the delivery and collection methods, the base station and the collection and analysis device, and the system according to the invention in combination have all or some of the aforementioned features.

### BRIEF DESCRIPTION OF THE DRAWINGS

Further features and advantages of the present invention will become apparent from the following description, with reference to the appended drawings, which illustrate an exemplary embodiment that is by no means limiting. In the figures:

FIG. 1 shows, in its environment, a system in a network according to the invention, in a first embodiment;

FIG. 2 schematically shows the hardware architecture of a base station and of a collection and analysis device of the system of FIG. 1, according to the invention;

FIG. 3 shows the functional modules of a base station and of a collection and analysis device of the system of FIG. 1, according to the invention;

FIG. 4 illustrates the steps of the delivery and collection methods implemented by the system of FIG. 1 in a particular embodiment.

### DESCRIPTION OF THE INVENTION

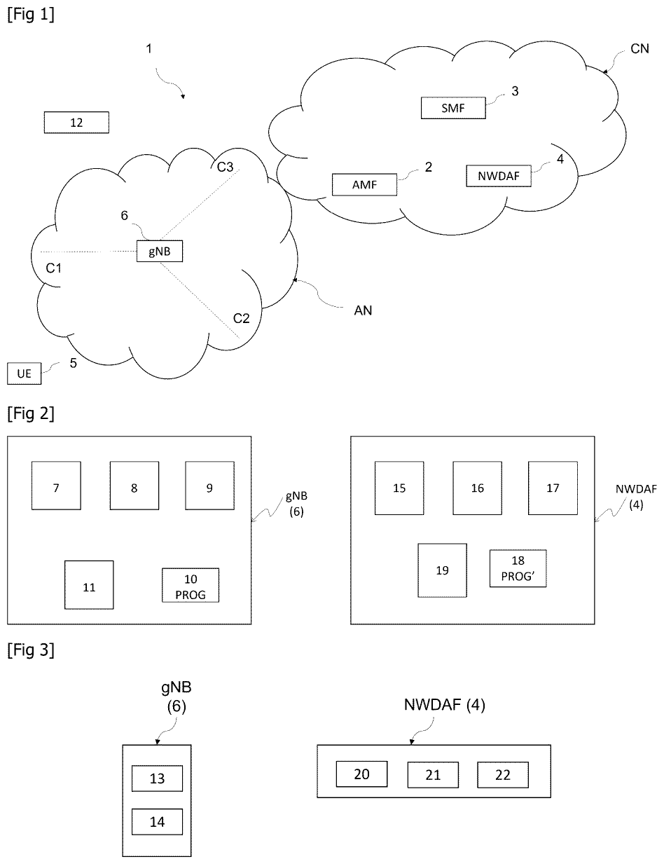

FIG. 1 shows a system 1 in a cellular communication network NW, according to the invention, in a particular embodiment. The network NW in this case is a 5G network as defined by the 3GPP standard, managed by an operator OP; it comprises at least one access network AN and a core network CN.

In a manner known per se, the core network CN uses a plurality of network functions, or NF, offering various services and implementing various functionalities in the core network CN, such as, for example, an AMF function managing network access and the mobility of the UEs linked to the network, an SMF function managing the sessions established in the network, an NRF function maintaining the profiles of the NF functions of the network, an NWDAF function for collecting and analyzing network data, etc. One or more instances of each of the NF functions of the core network CN can be deployed to ensure the operational functioning thereof. In the example of FIG. 1, the following are notably considered: a device 2 hosting an AMF network function instance, a device 3 hosting an SMF network function instance and a device 4 hosting an NWDAF network function instance. Of course, this example is provided solely by way of illustration and by no means limits the invention.

In order to access the services offered by the network NW, a user equipment or UE 5 connects to the core network CN via the access network AN, and more specifically via a gNB base station 6 of this access network. The nature of the UE 5 is by no means limiting: it can be a smartphone, a laptop computer, a tablet, an object, a machine or a connected vehicle, etc.

In a manner known per se, each gNB base station (and in particular the base station 6) is configured to manage one or more cells of the network NW. The term “cell” is understood herein to mean a “unitary” geographical area of the network NW, to which geographical area a cell identifier (or “NR Cell Identity”) uniquely designating said area and transmission parameters (for example, a frequency band) are associated. It should be noted that the same transmission parameters can be simultaneously used by several cells of the network duly distributed in order to limit any interference. Thus, in the example of FIG. 1, it is assumed that the base station 6 is a tri-sectorial gNB and thus manages three cells of the network C1, C2 and C3, respectively corresponding to the three sectors covered by the base station 6.

There is no limit associated with the type of base stations considered for the access network AN. Fixed and/or mobile base stations (for example, on board a vehicle, in a drone or more generally in any system capable of moving) can be contemplated.

According to the invention, the system 1 comprises:
at least one gNB base station managing at least one cell of the network NW and, according to the invention, namely, in the example of FIG. 1, with the base station 6 managing the cells C1, C2 and C3; and
at least one data collection and analysis device of the network NW, according to the invention, namely, in the example of FIG. 1, the device 4 hosting the NWDAF function instance.

In the first embodiment described herein, each base station of the system 1 according to the invention (including the base station 6) has the hardware architecture of a computer, as shown in FIG. 2. This computer notably comprises a processor 7, a random-access memory 8, a read-only memory 9, a non-volatile memory 10, and communication means 11 notably allowing each base station to communicate with the UE 5, as well as with other elements of the network NW, and notably with devices of the core network CN, such as the NWDAF device 4, or with other elements outside the network NW, such as, for example, with a radio planning system 12 adapted to the network NW (for example, that used by the operator OP of the network NW to deploy their network). The communication means 11 notably implement, in the embodiment described herein, a programming interface or API in order to communicate with the devices of the core network CN, allowing it to expose information intended for these devices of the core network CN.

The non-volatile memory 10 of the computer forms a storage medium according to the invention that can be read by the processor 7 and that stores a computer program PROG according to the invention comprising instructions defining the main steps of a delivery method according to the invention.

The program PROG defines the functional modules of a base station of the system 1 (such as the base station 6) that use or control the aforementioned hardware elements 7 to 11 of the computer.

These modules notably comprise, in the embodiment described herein, as illustrated in FIG. 3:
a receiving module 13, configured to receive polls (i.e., requests) from data collection and analysis devices of the network NW, and in particular in this case from the NWDAF device 4; and
a transmission module 14, configured to send the collection and analysis devices that polled the base station in question information, denoted INFO_CURR herein, representing current deployment conditions of at least one cell of the network managed by said base station.

In the embodiment described herein, the base station according to the invention implements an Application Programming Interface (API), notably in order to expose the information INFO_CURR representing the current deployment conditions of the cells of the network that it manages and that the reception 13 and transmission 14 modules use. The advantage of such an API is that it is universal and allows access to the information INFO_CURR for any device of the network NW (in particular for the devices of the core network CN hosting network functions, or NFs) configured to invoke the API.

In an alternative embodiment, another type of interface can be contemplated for communicating this information, and in particular a point-to-point interface using a protocol similar or identical to the NGAP (“NG Application Protocol”) protocol defined in 3GPP document TS 38.413 entitled “Technical Specification Group Radio Access Network; NG-RAN; NG Application Protocol (NGAP); (Release 17)”, V17.0.0, April 2022, implemented between the base station according to the invention (for example, gNB 6) and the NWDAF device 4.

The operation of the modules 13 and 14 is described in further detail hereafter with reference to the steps of the delivery method according to the invention.

Similarly, in the embodiment described herein, each collection and analysis device of the system 1 according to the invention (including the NWDAF device 4) has the hardware architecture of a computer, as shown in FIG. 2. This computer notably comprises a processor 15, a random-access memory 16, a read-only memory 17, a non-volatile memory 18, and communication means 19 notably allowing each collection and analysis device to communicate, on the one hand, with the base stations of the system 1 (and notably with the base station 6, in particular by invoking the API implemented thereby in order to expose the information INFO_CURR concerning current deployment conditions of the cells that it manages), and, on the other hand, with devices of the core network CN. In the embodiment described herein, the communication means 19 are notably configured to communicate with the base stations of the system 1 and with the devices of the core network CN using APIs provided to this end.

The non-volatile memory 18 of the computer forms a storage medium according to the invention, which can be read by the processor 15 and which stores a computer program PROG′ according to the invention comprising instructions defining the main steps of a collection method according to the invention.

The program PROG′ defines the functional modules of a collection and analysis device according to the invention (such as the NWDAF device 4) that use or control the aforementioned hardware elements 15 to 19 of the computer. These modules notably comprise, in the embodiment described herein, as illustrated in FIG. 3:
a polling module 20, configured to poll (i.e. query) at least one base station of the system 1, and notably the base station 6, via the API implemented by said base station;
a receiving module 21 configured to receive information from said at least one polled base station (via the aforementioned API) representing current deployment conditions of at least one cell of the network managed by said at least one base station; and
an analysis module 22, configured to use all or some of said received information when analyzing network data.

The operation of the modules 20 to 22 of the collection and analysis device according to the invention is described in further detail hereafter with reference to the steps of the collection method according to the invention.

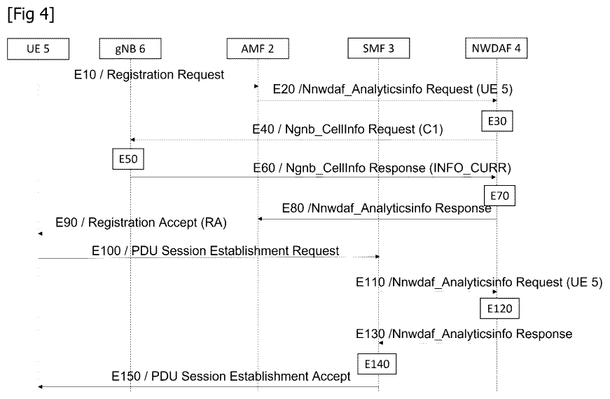

The main steps of the delivery and collection methods according to the invention will now be described with reference to FIG. 4, when they are respectively implemented, in the embodiment described herein, by the base station 6 and by the NWDAF device 4 of the system 1.

It is assumed that the UE 5 registers with the core network CN via the base station 6 (step E10). In a manner known per se, the registration request of the UE 5 is sent to an AMF instance. In the example of FIG. 1, it is assumed that it is the AMF instance hosted by the device 2 (also equally referred to hereafter as AMF device 2).

Upon reception of the registration request from the UE 5, the AMF device 2 asks the NWDAF device 4 for predictions/statistics concerning the UE 5, such as, for example, predictions concerning the mobility of the UE 5 (“Nnwdaf_AnalyticsInfo Request” message) (step E20). To this end, in the embodiment described herein, it uses the Nnwdaf_AnalyticsInfo service described in 3GPP documents TS 23.288 entitled “Architecture Enhancements for 5G system (5GS) to support network data analytics services (Release 17)”, V17.4.0, March 2022, and TS 28.520 entitled “Technical Specification Group Core Network and Terminals; 5G System; Network Data Analytics Services; Stage 3; (Release 17)”, V17.6.0, March 2022. It should be noted that this request can occur in the form of a simple “Nnwdaf_AnalyticsInfo Request” request, as described herein, or, as a variant, can occur in the form of a subscription, as described in the aforementioned documents TS 23.288 and TS 29.520.

Upon reception of the request for predictions from the AMF device 2, the NWDAF device 4 collects the data INPUT_DATA required for computing the requested predictions, as described in document TS 23.288, paragraph 6.7.2.4 (step E30). Furthermore, it uses its polling module 20 to poll at least one gNB base station of the system 1 in order to acquire information INFO_CURR representing the deployment conditions of the cells managed by said at least one base station (step E40).

Such information INFO_CURR reflects the actual deployment of the network NW at a given instant, i.e., the geographical areas and the infrastructures covered by the cells of the network NW, the topology of the architecture of the network NW (for example, adjacency between cells), etc. They are dynamic in the sense that they can evolve over time, depending on the decisions taken by the operator OP of the network NW or autonomously by the base stations (for example, reconfiguration of certain base stations, etc.), on the movement of the base stations (notably when they are mobile), on the suppression of some cells (for example, in order to limit the energy consumption of the network), on the appearance of new infrastructures (for example, roads, buildings, etc.), etc.

Thus, for example, the information INFO_CURR representing the current deployment conditions of a cell managed by a base station can include all or some of the following information:
information relating to the arrangement of the cell in the network architecture, such as the logical or radio neighborhood of the cells (in the form, for example, of the identity of the neighboring cells of said cell);
information relating to the geographical environment of the cell, such as the geographical area covered by the cell (expressed, for example, based on the coordinates (latitude and longitude) of the center of the cell and its radius, or on a polygonal spatial pattern using the same type of coordinates or via a reference to a coverage map, etc.);
information relating to the type of deployment of the cell, such as an indoor/out-door, direct (LOS) or indirect (NLOS) line-of-sight deployment, in a white, dense, suburban or rural area, having a coverage or capacity function, in support of a private network, of an infrastructure or of a vertical critical orbit, event-driven/temporary deployment, configuration of the deployment (for example, macro/small/pico-cell, or cell managed by a base station on board a high-altitude platform, a drone or a satellite, etc.);
information relating to a configuration of at least one antenna of the cell, such as the position and the orientation of this antenna (latitude, longitude, altitude, ground height, azimuth, incline), the deployment of a distributed antenna system (or DAS);
information relating to at least one infrastructure covered by the cell, for example a main road, a railway track, a waterway, one or more buildings, an industrial zone, etc. (expressed, for example, in the form of the identity of the infrastructure in question);
information relating to the state of the cell, such as the load or the load level (for example, low, medium, high) of the cell, the load or the load level of the cell on each network slice, the number of active users in the cell, the uplink (UL) or downlink (DL) throughput, congestion indicators (for example, radio resource utilization rate, number of queued packets), a fault state or an alarm level, a security state (for example, jamming detection, the detection of attacks of the “Man In The Middle Attack” or “false base station”, “Distributed Denial of Service” (DDOS), botnet compromise type, etc.).

Of course, this list is not exhaustive and other information representing the current deployment conditions of the cells can be contemplated within the context of the invention.

Furthermore, the polling module 20 can request to acquire other information in addition to the information INFO_CURR concerning a cell, such as information INFO_SUPP concerning the static configuration of the cell, such as an identity of the cell, a frequency band used by the cell, at least one radio access technology associated with the cell (for example, GERAN, UTRA, E-UTRA, NR), etc. It should be noted that some of these items of information that are currently static within the context of 5G networks can be considered to express a more dynamic nature in a subsequent release of these networks or in another context.

The polling module 20 can also request, from each base station that it polls, information that is related thereto, denoted INFO_gNB herein, such as its identity (in the form, for example, of a “Global RAN Node ID” identifier), the list of TAs and/or network slices that it supports, information representing its state (for example, load or load level, number of users using the base station), etc.

The polling module 20 can equally poll all the base stations of the system 1, or can poll only a selected portion of the base stations as a function of one or more selection criteria.

Typically, the base stations of the system 1 polled by the polling module 20 can depend on the predictions requested by the AMF device 2. Thus, in the illustrative example contemplated in this case, with the AMF device 2 having asked the NWDAF 4 device for predictions concerning the mobility of the UE 5 linked to the base station 6, the polling module 20 of the NWDAF device 4 can decide to poll only the base station 6.

Similarly, the polling module 20 can target the information that it wishes to receive from the polled base stations. In the preceding illustrative example, it may notably ask to receive only information relating to the current deployment conditions of the cell linked to the UE 5, for example the cell C1 managed by the base station 6, or, as a variant, all the cells C1, C2 and C3 managed thereby. The identifier of the cell used by the UE 5 (C1 in the example contemplated in this case) can be acquired by the NWDAF device 4, for example based on the data INPUT_DATA that it has collected.

In an alternative embodiment, it can use the raw data INPUT_DATA that it has collected, or statistics/predictions that it has established based on this raw data, in a manner known per se, to select the relevant base stations to be polled and/or the deployment condition information to be requested from these base stations. Typically, in the preceding illustrative example, it can use a first mobility prediction established based on the raw data INPUT_DATA and can select the base stations managing the cells that are located on a trajectory of the UE 5 in terms of this prediction, as well as the deployment information that it wishes to acquire from these base stations, for example information concerning the arrangement of the cells managed by these base stations in the network architecture (adjacent cells, etc.), the type of deployment of each of these cells and the infrastructures that they cover.

Of course, these examples are provided solely by way of illustration, and other selection criteria can be contemplated as a variant or in addition to those already cited for selecting the base stations to be polled and/or the information to be requested from them.

In the embodiment described herein, during step E40, the polling module 20 polls each base station that it has selected by using a service called Ngnb_CellInfo herein. Such a service in this case uses the APIs of the polled base stations and is designed for the requirements of the invention: it can notably use the same protocol (for example, the HTTP/2 (“HyperText Transfer Protocol/2”) protocol) as the services already defined by the 3GPP standard, such as the Nnwdaf_AnalyticsInfo service or any other service defined by the 3GPP standard, to allow an NF function of the core network CN to access the functionalities implemented by another function NF and exposed thereby via its API.

As a variant, as mentioned above, other types of interface can be contemplated for interacting with the base stations, such as, for example, a point-to-point interface using a protocol similar or identical to the NGAP protocol defined in the aforementioned 3GPP specification, TS 38.413.

During step E40, the polling module 20 polls each selected base station by sending it a request (“Ngnb_CellInfo Request” message) defined by the Ngnb_CellInfo service concerning (i.e., implicitly or explicitly indicating) the information INFO_CURR that it wishes to receive (and optionally other information INFO_SUPP and INFO_gNB as mentioned above). In the example contemplated in FIG. 4, it is assumed, for example, that the polling module 20 has selected the base station 6, to which the UE 5 is linked, and sends it an “Ngnb_CellInfo Request” request concerning the information INFO_CURR relating to the cell C1 in which the UE 5 is located.

The relevant information INFO_CURR can be explicitly identified in the “Ngnb_CellInfo Request” request by means of predefined coding, in a manner known per se, shared between the NWDAF device 4 and the base stations of the system 1. For example, it is possible to associate a distinct integer value with each item of information INFO_CURR that can be provided by a base station, and to upgrade a field of the request with the values associated with the information desired by the NWDAF device 4. As a variant, a list of information can be contemplated that is defined by default on the base stations of the system 1, with the absence of an explicit reference in the request sent by the NWDAF device 4 meaning that said device is interested in all the information specified in this list.

Upon reception of the request from the NWDAF device 4 by its receiving module 13 (in other words, after being polled), the base station 6 uses its transmission module 14 to identify and acquire the information INFO_CURR (and, if applicable, the information INFO_SUPP and INFO_gNB) requested by the NWDAF device 4 (step E50).

It should be noted that the information INFO_CURR, INFO_SUPP and/or INFO_gNB may have been configured on the base station 6 (and more generally on each base station of the system 1) by the operator OP of the network NW (via means that are known per se and are not described herein), or may have been acquired or discovered dynamically by the base station 6 before it is sent to the NWDAF device 4.

For example, the base station 6 can evaluate some of this information itself, such as the geographical area covered by each of the cells C1, C2 and C3 that it manages. To this end, it can notably use the geographical location of the UEs that are linked to the cell in question, with this location being able to be fed back by satellite positioning modules (or PNT, for “Positioning Navigation and Timing Service”), such as GPS or GNSS modules installed on the UEs, or being able to be computed by the base station 6 based on the TDOA and speed information it has on the UEs. By virtue of the location of the UEs and the knowledge of the cells serving each of these UEs, the base station 6 can establish a “map” of the UEs and deduce the coverage limits of each cell therefrom.

According to another example, which is particularly well adapted in the case of a mobile base station 6 equipped with a PNT receiver and a compass, the base station 6 can evaluate the position and the orientation of the antennas serving the cells that it manages based on the positions fed back by its PNT receiver and the indications provided by its compass.

According to yet another example, the base station 6 can determine the identity of the neighboring cells of each cell that it manages by using the ANR (“Automatic Neighbor Relation”) functionality of SON (“Self-Organizing Networks”) technology that is designed, in a manner known per se, to allow self-configuration, self-exploitation and self-optimization of the equipments of a cellular communication network.

According to another example, the base station 6 can deduce information relating to the state of the cell from its own state: for example, if the base station 6 encounters an overload problem typically caused by the limitation of its processing capacities, this will have repercussions on the state of the cells that it manages, which themselves will be in an overloaded state.

Furthermore, the base station 6 has, in a manner known per se, information concerning the use of the network resources. Based on this information, it can detect a state (or a level) of congestion of the cells that it manages. Such congestion is likely to affect various types of resources used by the cell, such as radio resources or PRBs (“Physical Resource Block”), buffers or even radio channels (for example, traffic, signaling or paging channels), and intervenes when 100% of the resources in question are used (for example, 100% of the buffers are full). In order to detect such a state, various advanced congestion indicators can be monitored such as, for example, a utilization percentage of the resources that approaches a critical threshold, an increase in the delays or losses of packets observed on the cell, etc. These indicators can be considered from the information INFO_CURR.

The base station 6 can also acquire some of the third-party entity information, for example entities of the network NW or external entities. Notably, it is possible to contemplate that the base station 6 is configured to communicate with the radio planning system 12 adapted to the network NW, and acquires certain information from this radio planning system, such as, for example, the information relating to the type of deployment of the cells C1, C2 and C3 that it manages, the identity of the infrastructures covered by each of these cells, or even the information relating to the deployment configuration of these cells.

The base station 6 also may be aware of some of this information because it uses it to implement the processing operations for which it is responsible (for example, identity of the neighboring cells, frequency band used by each cell or even access network technology implemented in each cell), or because it is configured to broadcast this information over the network NW (for example, the identity of the cells managed by the base station 6, list of TAs and/or network slices that it supports).

The nature of the information INFO_CURR, and, if applicable, INFO_SUPP and INFO_gNB, configured and/or acquired by the base station 6 can be defined on the base station 6 by default, for example by the operator of the network NW, or by a management platform, also known as OAM (“Operations, Administration and Maintenance”) platform.

Once the information INFO_CURR (and, if applicable, INFO_SUPP and/or INFO_gNB) requested by the NWDAF device 4 is acquired, the base station 6 uses its transmission module 14 to send it to the NWDAF device 4 (step E60). To this end, the transmission module 14 in this case uses the API of the base station 6, allowing it to expose the information INFO_CURR (and, if applicable INFO_SUPP and/or INFO_gNB) requested from it to the NWDAF device 4. More specifically, it sends it a response (“Ngnb_CellInfo Response” message), via this API, to its request that is defined by the Ngnb_CellInfo service and that contains the requested information INFO_CURR (and, if applicable, INFO_SUPP and/or INFO_gNB).

It should be noted that, as a variant, the NWDAF device 4 can poll the base station 6 (or, more generally, all or some of the base stations of the system 1) via a subscription mechanism, which is known per se. More specifically, the NWDAF device 4 can use its polling module 20 to subscribe to the base station 6 (or, more generally, all or some of the base stations of the system 1) for notifications of events likely to affect the current deployment conditions of all or some of the cells managed thereby. When such an event is detected by the base station 6, the transmission module 14 of the base station 6 sends a notification message concerning this event to the NWDAF device 4 that contains the information representing the current deployment conditions of the cells affected by the event. In an alternative embodiment, the notification that it transmits may contain only the information that has changed due to the event.

The response is received by the receiving module 21 of the NWDAF device 4. The NWDAF device 4 uses its analysis module 22 to then establish the predictions requested by the AMF device 2 by using, on the one hand, the collected data INPUT_DATA, but also, on the other hand, all or some of the information received by its receiving module 21 from the gNB base station 6, in particular all or some of the information INFO_CURR concerning current deployment conditions of the cell C1 received from the gNB base station 6 (step E70). For example, the mobility predictions of the UE 5 carried out by the NWDAF device 4 can be influenced by the type of deployment of the cell C1 and notably the fact that it is deployed in support of a given infrastructure, such as a highway: the future positions of the UE 5 located on this highway will then have a higher probability. Of course, this example is provided solely by way of illustration and is not limiting per se.

The analysis module 22 of the NWDAF device 4 sends the predictions thus established to the AMF device 2 (“Nnwdaf_AnalyticsInfo Response” message) (step E80), which uses them, for example, to establish the RA of the UE 5 in a manner that is known to a person skilled in the art and is not described in detail herein (step E90). For example, the RA can contain all the TAs containing the future positions of the UE 5 predicted by the NWDAF device 4. Of course, this example is provided solely by way of illustration and is not limiting per se.

The other steps of the registration procedure for the UE 5 are identical or similar to the steps described in document 3GPP TS 23.501, and are not described in further detail herein.

The AMF device 2 sends the registration confirmation (“Registration Accept”) to the UE 5, with this confirmation including the RA that it has just determined (step E90).

Following its registration, it is assumed in this case that the UE 5 needs to establish a session (“PDU Session Establishment Request”) (step E100). The AMF device 2 through which the request passes determines, in a manner known per se, the SMF instance that will manage this session (the SMF instance 3 in the example contemplated in this case), as defined in the 3GPP standard. Optionally, it can use the predictions received during step E80 to identify the SMF device 3 that will manage this session.

Upon reception of the session establishment request, the SMF device 3 in this case in turn asks the NWDAF device 4 for predictions/statistics concerning the UE 5, for example predictions concerning the communications of the UE 5 (“Nnwdaf_AnalyticsInfo Request” message) (step E110). As described above for the AMF device 2 in step E20, the SMF device 3 to this end uses, in the embodiment described herein, the Nnwdaf_AnalyticsInfo service described in 3GPP documents TS 23.288 and TS 28.520. Steps E30-E60 can be reiterated if necessary by the NWDAF device 4 (not shown in FIG. 5).

The NWDAF device 4 uses its analysis module 22 to then establish the predictions requested by the SMF device 3 by using, on the one hand, the data INPUT_DATA that it has collected (the data collected during step E30 and/or new data if they are not relevant or are no longer relevant given the requested predictions), but also, on the other hand, all or some of the information provided by the base station 6 concerning the cell C1 used by the UE 5 to access the network, and in particular all or some of the information INFO_CURR concerning current deployment conditions of the cell C1 (step E120).

It should be noted that the NWDAF device 4 can, if necessary, poll the gNB base station 6 again, as described above during step E40, if the information INFO_CURR acquired in step E30 is not relevant for establishing the predictions requested by the SMF device 3 (for example, because these predictions differ from those requested by the AMF device 2), or in order to be notified of any changes in the information INFO_CURR (to this end, it can also subscribe to the base station 6 for notifications of events affecting the information INFO_CURR of the cells that it manages, in a manner known per se).

In general, the NWDAF device 4 can poll the base station 6 directly in connection with a request for predictions/statistics from a network device, or asynchronously. It can also, for the same request, query the base station 6 several times. For example, the NWDAF device 4 can observe the movement of the UE 5 for a certain period and query the base stations managing each of the cells visited by the UE 5 in order to acquire more reliable predictions. This is notably possible when the device requesting predictions/statistics does not need an immediate response.

The analysis module 22 of the NWDAF device 4 sends the predictions that it has established to the SMF device 3 (“Nnwdaf_AnalyticsInfo Response” message) (step E130), which uses them to establish the session requested by the UE 5 (step E140). For example, the SMF device 3 uses these predictions to optimally determine some parameters of the session, such as the one or more network functions of the user plane, or UPF (“User Plane Function”), that will route the data. For example, depending on the throughputs of the communications of the UE 2 predicted by the NWDAF device 4, the SMF device 3 can select an optimized UPF function to process a high throughput or, on the contrary, to process sporadic communications. Of course, this example is provided solely by way of illustration and is not limiting per se.

The SMF device 3 then confirms the establishment of the session with the UE 5 (“PDU Session Establishment Accept” message) (step E150).

In the embodiment described herein, the AMF and SMF devices, 2 and 3, each in turn query the NWDAF device 4 to acquire predictions/statistics, and use these predictions/statistics to implement the functionalities assigned to them. Of course, these assumptions are not limiting per se, and it is possible to contemplate that only one of the devices requests and uses such predictions/statistics.

In the embodiment described herein, an API and an Ngnb_CellInfo service are used on the base stations of the system 1 to expose the information (and in particular the information INFO_CURR, INFO_SUPP and INFO_gNB) to the NWDAF device requesting it. As emphasized above, the advantage of using such an API is that it can be used by devices of the network NW other than the NWDAF device as long as these devices are configured to invoke (i.e., use) such an API. Thus, in another embodiment of the invention, the system according to the invention can comprise at least one device hosting a network function of the core network CN (such as, for example, a device hosting an AMF function, an SMF function, etc.), configured to invoke the APIs of the base station and to use this API to directly poll the base station in order to acquire information INFO_CURR (in a similar or identical manner to that described for the NWDAF device during step E40). The device in question can then use the information INFO_CURR thus collected to implement the functionalities of the network function that it implements.

As a variant, communication interfaces can be contemplated between the base stations of the system 1 and the NWDAF device other than an API, as indicated above. The same applies to the other services activated above (for example, Nnwdaf_AnalyticsInfo).

Furthermore, the invention has been described with reference to a 5G context. However, it also can be applied in other contexts, for example in a 6G network or in a proprietary network.

1. A method for delivering information using a base station of a cellular communications network, said method comprising, after being polled by a data collection and analysis device of the network, transmitting collection and analysis device information representing current deployment conditions of at least one cell of the network managed by the base station.

2. The method of claim 1, wherein the information is transmitted to the collection and analysis device by exposing the information via an application programming interface of the base station.

3. The method of claim 1, wherein said polling by the collection and analysis device involves receiving a request from the collection and analysis device concerning said information, with said information being sent in a response to said request.

4. The method of claim 1, wherein said polling by the collection and analysis device involves the collection and analysis device subscribing to the base station for notifications of events likely to affect said current deployment conditions of said at least one cell, with said information being sent in a notification of at least one of said events.

5. The method of claim 1, further comprising evaluating at least a portion of said information before transmitting said information to said collection and analysis device.

6. The method of claim 1, further comprising acquiring, from a radio planning system adapted to the network, at least a portion of said information before transmitting said information to said collection and analysis device.

7. The method of claim 1, wherein the transmission step also comprises transmitting to the collection and analysis device:
an identity of said at least one cell; and/or
a frequency band allocated to said at least one cell; and/or
at least one radio access technology associated with said at least one cell.

8. A method for collecting data using a data collection and analysis device of a cellular communication network, said method comprising:
receiving information from at least one base station of the network polled by said collection and analysis device, with said information representing current deployment conditions of at least one cell of the network managed by said at least one base station; and
using all or some of said received information when analyzing network data.

9. The method of claim 8, wherein said at least one base station is polled by the collection and analysis device by sending a request concerning said information, with said information being received in a response from the base station to said request.

10. The method claim 8, wherein said at least one base station is polled by the collection and analysis device by subscribing to the base station for notifications of events likely to affect said current deployment conditions of at least one of said cells managed by the base station, with said information being received in a notification from the base station of at least one of said events.

11. The method of claim 8, further comprising sending a result of said analysis to another network device that requested this analysis.

12. The method claim 11, wherein said result comprises a prediction of the mobility of a user equipment managed by said other network device.

13. The method of claim 8, further comprising a preliminary step of selecting at least one polled base station, with said selection being carried out as a function of at least one given selection criterion and/or of at least one of said items of information representing current deployment conditions of at least one cell.

14. The method of claim 8, wherein at least one of said items of information representing current deployment conditions of a cell relates to an arrangement of the cell in a network architecture, to a geographical environment of the cell, to a configuration of at least one antenna of the cell, to a type of deployment of the cell, to at least one infrastructure covered by the cell, and/or to a state of the cell or of the base station managing said cell.

15. A base station of a cellular communications network, the base station comprising a transmission module activated after being polled by a data collection and analysis device of the network, with said transmission module being configured to transmit collection and analysis device information representing current deployment conditions of at least one cell of the network managed by the base station.

16. A data collection and analysis device of a cellular communications network, the collection and analysis device comprising:
a polling module, configured to poll at least one base station of the network;
a receiving module, configured to receive information from said at least one polled base station representing current deployment conditions of at least one cell of the network managed by said at least one base station; and
an analysis module, configured to use all or some of said received information when analyzing network data.

17. A system (1) of a cellular communications network comprising:
the data collection and analysis device of claim 16; and
a base station comprising a transmission module activated after being polled by the data collection and analysis device of the network, with said transmission module being configured to transmit said collection and analysis device information representing current deployment conditions of at least one cell of the network managed by the base station.

18. The system of claim 17, wherein the base station is configured to implement an application programming interface in order to expose said information representing current deployment conditions of at least one cell of the network managed by the base station, and wherein said system comprises at least one other device of the network hosting a network function and configured to invoke the application programming interface implemented by the base station.

19. The method of claim 1, wherein at least one of said items of information representing current deployment conditions of a cell relates to an arrangement of the cell in a network architecture, to a geographical environment of the cell, to a configuration of at least one antenna of the cell, to a type of deployment of the cell, to at least one infrastructure covered by the cell, and/or to a state of the cell or of the base station managing said cell.
